(19) United States
(12) Patent Application Publication
(10) Pub. No.: US 2022/0124124 A1
(43) Pub. Date: Apr. 21, 2022

(54) Adaptive Communication Platform

(71) Applicant: Agile Solutions, LLC, Port Washington, NY (US)

(72) Inventor: Seth Cirker, Port Washington, NY (US)

(21) Appl. No.: 17/502,919

(22) Filed: Oct. 15, 2021

Related U.S. Application Data
(60) Provisional application No. 63/093,001, filed on Oct. 16, 2020.

(51) Int. Cl. H04L 29/06; H04L 5/00

(52) U.S. Cl. CPC H04L 65/1069; H04L 65/607; H04L 5/0055; H04L 65/403

(57) ABSTRACT

A communication system is provided comprising, a user communication device that includes at least one user input device, whereupon interaction with the user input device causes a communication request to be generated, wherein the generated communication request includes at least a data value, and a request type value; a communication server configured to receive the generated communication request and to parse the generated communication request to determine at least the request type and the data value and compare the request type and the data value to a lookup table of potential recipients of the communication request depending on the data value and request type, determining the availability of a recipient by at least polling the network status of a communication device associated with each potential recipient, identifying an available recipient and initiating a communication session between the user communication device and the communication device associated with the selected available recipient.

### CROSS REFERENCE TO RELATED APPLICATION

The present application claims the benefit of U.S. patent application Ser. No. 63/093,001, filed Oct. 16, 2020, which is hereby incorporated by reference in its entirety.

### FIELD OF THE INVENTION

The present invention is directed communications devices that are configured for use by users with differing levels of technical skill, mobility, or accessibility.

### BACKGROUND OF THE INVENTION

Communications devices, such as standalone video conferencing devices or a software implemented application executing on consumer hardware, continue to obtain wide adoption in the general population. Furthermore, increased disruptions due to pandemics (such as COVID-19), and other natural and man-made events, have established the routine use of video conferencing technology as a means of allowing individuals to remain in contact with one another when in-person meetings are not possible or advisable.

However, such devices are typically designed for use by the general public or those users that have a degree of familiarity and adaptability with existing video conferencing solutions.

Furthermore, prior to use, video conferencing software or apps first need to be downloaded, installed, and configured. Likewise, user accounts need to be established for individual users. Such video conferencing software often needs to be continually monitored, ensuring it is running with internet connectivity, and restarted when necessary, to ensure the video conferencing solution is operational when needed. These requirements alone frequently prevent wide use or adoption of such software by many individuals including non-tech-savvy users and those with disabilities/cognitive impairments or when such technical support resources are not feasible due to COVID-19 concerns or other reasons.

Therefore, what is needed in the art are communication devices and technology that is self-configuring or remotely configurable so as to work without user set-up. Furthermore, what is needed in the art are easy-to-use communication devices and technology that prevent misconfigurations of the communications device. Additionally, what is needed in the art are communication devices that can be remotely controlled or operated so as to allow remote users to assist a local user in the operation thereof.

### SUMMARY OF THE INVENTION

In one particular implementation, a communication system is provided comprising: at least two user communication devices configured to send and receive at least audio-video data, and the at least two user communication devices are configured to broadcast their respective availability for a communication session; and a communication server configured by one or more software modules to mediate a communication linkage between the at least two user communication devices. In a further implementation, the communication server is further configured to receive from a first user communication device of the at least two communication devices a request to initiate a communication session with a second of the at least two user communication devices and transmit, to the second of the at least two user communication devices, the request to initiate a communication. In a further implementation, at least one of the communication devices is designated as a client participation device, wherein during the duration of the communication session, a user interface of the client participation device is configured to not display a function to terminate the communication session.

In a further particular implementation, a communication system is provided comprising: one or more communication devices configured to communicate over a communications network and further configured to broadcast on the communications network, on a periodic schedule, a status notification and a network monitoring appliance configured to access the communications network and receive the broadcast status notification, generate an alert where a status notification from any of the one or more communication devices is not received according to the periodic schedule, and transmit the alert using the communications network. The system also includes a recipient communication device configured to receive alerts transmitted by the network monitoring appliance, wherein the alert received include data values associated with the one or more communication devices that caused the generation of the alert. In a further implementation, the status notification includes at least one geographic location indicator. In yet a further configuration, the network monitoring appliance is further configured to identify at least one prior location of one or more communication devices that caused the generation of the alert based on the at least one geographic location indicator, determine, from a received status notifications, at least one of the one or more communication devices that is within a pre-determined geographic range of the one or more communication devices that caused the generation of the alert; and route a communication request addressed to the one or more communication devices that caused the generation of the alert to the identified at least one of the one or more communication devices within the pre-determined geographic range.

In one particular implementation, a communication system is provided comprising, a user communication device that includes at least one user input device, whereupon interaction with the user input device causes a communication request to be generated, wherein the generated communication request includes at least a data value, and a request type value; a communication server configured to receive the generated communication request and to parse the generated communication request to determine at least the request type and the data value and compare the request type and the data value to a lookup table of potential recipients of the communication request depending on the data value and request type, the communication server further configured to determine the availability of a recipient by at least obtaining availability data regarding the network status of a communication device associated with each potential recipient and identify an available recipient; the communication server further configured to initiate a communication session between the user communication device and the communication device associated with the selected recipient. In one or more further implementations, the data value is a time value. In a further implementation, the communication uses a polling function to poll the availability of the recipient communication devices. In a further implementation, each user communication device is configured to report the status or active sockets to a server at regular intervals.

### BRIEF DESCRIPTION OF THE DRAWINGS

FIG. 1 is a schematic illustration detailing particular elements of the described communication system.

FIG. 2 is a block diagram detailing particular functions of the communication system.

FIG. 3 is a schematic diagram of the user communication apparatus.

FIG. 4 is a flow diagram of the steps of initiating a communication according to one particular implementation.

FIG. 5 is a flow diagram of the steps of initiating a communication according to one particular implementation.

FIG. 6 is a diagram detailing particular features of the communication platform communication according to one particular implementation.

FIG. 7 is a diagram detailing particular features of the communication platform communication according to one particular implementation.

FIG. 8 is a diagram detailing particular features of the communication platform communication according to one particular implementation.

FIG. 9 is a is diagram detailing particular features of the communication platform communication according to one particular implementation.

FIG. 10 is a diagram detailing particular features of the communication platform communication according to one particular implementation.

FIG. 11 is a diagram detailing particular features of the communication platform communication analysis according to one particular implementation.

FIG. 12 is a diagram detailing particular features of the communication platform communication according to one particular implementation.

FIG. 13 is a diagram detailing particular features of the communication platform communication according to one particular implementation.

FIG. 14 is a diagram detailing particular features of the communication platform according to one particular implementation.

FIG. 15 is a diagram detailing a particular feature of the communication platform communication according to one particular implementation.

FIG. 16 is a diagram detailing a particular feature of the communication platform communication according to one particular implementation.

FIG. 17 is a diagram detailing a particular feature of the communication platform communication according to one particular implementation.

FIG. 18 is a diagram detailing a particular feature of the communication platform communication according to one particular implementation.

### DETAILED DESCRIPTION OF CERTAIN EMBODIMENTS OF THE INVENTION

By way of overview and introduction, apparatus, systems and methods for adaptive enabled communications devices are provided. In one or more implementations, communication software that enables remote access and control of the communication linkage is provided. In another implementation, a communications platform, such as but not limited to, a video conferencing system is provided that when initially obtained is configured to enable automatic downloads, installs relevant software and configures the same without additional user input. In yet another implementation, the system described herein allows for the access and configuration of generally available communication applications. These generally available communication applications are then automatically configured for use by the intended users or “locked down” so as to prevent misconfiguration or configuration changes. In yet a further implementation, the communication software, device(s) and system(s) described herein are configured for little or zero installation requirements in order to operate with a pre-determined functionality. Furthermore, the provided communications software, devices and systems described herein are distributed or otherwise are provided with the functions and functionality relevant to allow the software, device or platform to initiate and participate in a communication session with other software, devices or platforms in an immutable state (locked down) so as to prevent accidental configuration changes. In yet a further implementation, the communication software, device(s) and systems described herein are configured to automatically generate, without user intervention, audio or video alerts that notify users, remote monitors, or designated contacts of the user, when the device is not operational. For example, the software, devices and platforms described herein are configured to provide an alert to a remote user or monitor when the communication device or network connectivity has failed. In such configurations a remote monitoring platform or software is monitoring the broadcast availability of a user's communication device. Where that device is no longer broadcasting its availability, the remote monitoring platform automatically notifies a pre-designated contact user to alert them of the loss of connection with the user's communication device.

In one or more implementations, the communication devices and systems described herein are configured so as to not require user knowledge of, or interaction with, the communication device's operating system in order to initiate or receive a communication. For example, the communication device is configured with an operating system that includes a configuration file that automatically restarts one or more pre-determined communication applications (voice, video, text) after a device reboot such, as following a power failure or operating system (OS) update.

More specifically, the apparatus, systems and methods described herein are directed to providing adaptive use solutions to users of various communications platforms. For example, an apparatus is described that provides a user with an adaptive user interface for a communication device. Such an adaptive interface allows for the communication device to be operated by users with varying levels of manual dexterity, visual acuity, and technical proficiency. Furthermore, such communication devices are configured by one or more software modules to allow different operational modes depending on the privacy level of the communication. In still a further implementation, the communication devices described herein are configured by one or more software modules to allow for dynamic analysis of users at initiation, prior to and during a communication session. Here, the dynamic analysis utilized by the communication device, software or platform can be used to automatically add or conference one or more additional parties to an on-going communication secession, where such additional parties are selected based on the dynamic analysis so as to deliver care and assistance to the user remotely.

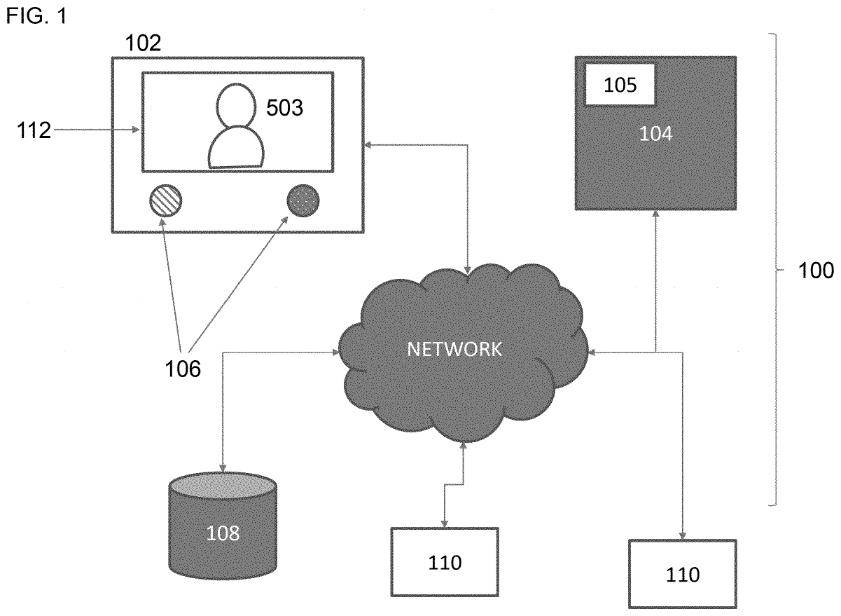

Turning now to FIG. 1, a communication system 100 is provided. Here the communication system 100 includes a communication interface device 102. The communication interface device 102 is configured to provide communication functionality to a user 503. For example, the communication interface device 102 is configured to allow an exchange of audio, video, multimedia, files, and data between users (503, 505, 507) of different communication interface devices 102.

In one or more implementations, the communication interface device 102 incudes one or more components, interfaces, or connections to one more processors, networks, or storage devices. In such an arrangement, the communication interface device 102 is configured to communicate with associated processors, networks, and storage devices using one or more direct connections, USB, FIREWIRE, Wi-Fi, GSM, Ethernet, Bluetooth, and other wired or wireless communication technologies suitable for the transmission audio, video, relevant data and or metadata. In an alternative arrangement, the communication interface device 102 is incorporated or a component of a smartphone, tablet, cell phone, workstation, testing bench, or other computing apparatus.

In one or more implementations, the communication interface device 102 is configured to capture audio, video, or other data from a user 503. Additionally, the communication interface device 102 is configured to receive audio, video, or other data from a remote user and provide that information to the user 503. For example, the communication interface device 102 includes or has access to one or more input devices 106, such as cameras (still, video or audio video) (1401), motion sensors, microphones (1403) or other devices uses to sense an environment or receive user input. In one particular implementation the input devices are integrated into a touch screen device. In an alternative arrangement, the input devices 106 are buttons, keypads, switches, toggles, or other input devices that are adapted for use by a user. In one or more implementations, the input devices 106 are software enabled inputs displayed on a touch screen or other touch enabled surface.

In a further implementation, the communication interface device 102 also includes one or more output devices 112, such as a display screen, speaker, LEDs, lights, manipulators, dials, or other output devices. In one implementation, the output device 112 is a screen, monitor, display, LED, LCD or OLED panel, augmented or virtual reality interface or an electronic ink-based display device. In one or more configuration, the output device 112 is a portion (such as defined by software) of a touchscreen display that is also configured to display software-based input devices 106.

In one or more implementations, the communication interface device 102 includes one or more custom or commercially available microprocessors, processing cluster, integrated circuit, computer on chip or other data processing devices that are configurable by software to exchange and process data according to the functions described herein. In one or more implementations, the display device 112, input devices 106 and other components of the communication interface device 102 are incorporated into a single housing.

The input data obtained by the communication interface device 102 are passed directly or indirectly to a computer or communication server 104 for evaluation and/or further processing. The communication server 104 is configured by one or more modules stored in memory 105 to derive analysis of the input, process the input or route data or communications. In an alternative configuration, the communication server 104 is able to access from the database 108 data to instruct one or more processors therein regarding the functioning of the communication device 102.

With further reference to FIG. 1, the communication server 104 is a computing device, such as a commercially available microprocessor, processing cluster, integrated circuit, computer on chip or other data processing device. In one or more configurations, the processor of the communication server 104 is one or more components of a cellphone, smartphone, tablet, notebook, or desktop computer configured to directly, or through a communication linkage, receive color measurement data captured by the communication device 102. The communication server 104 is configured with code executing therein to access various peripheral devices and network interfaces. For instance, the communication server 104 is configured to communicate over the Internet with one or more remote devices, such as communication interface device 102 or other servers, computers, peripherals, or other hardware using standard or custom communication protocols and settings (e.g., TCP/IP, etc.).

In a particular implementation, the communication server 104 comprises one or more of a collection of micro-computing elements, computer-on-chip, home entertainment consoles, media players, set-top boxes, prototyping devices, or “hobby” computing elements. The communication server 104 can comprise a single processor, multiple discrete processors, a multi-core processor, or other type of processor(s) known to those of skill in the art, depending on the particular embodiment.

In one configuration, the communication server 104 is a portable computing device such as an Apple iPad/iPhone® or Android® device or other commercially available mobile electronic device executing a commercially available or custom operating system, e.g., MICROSOFT WINDOWS, APPLE OSX, UNIX or Linux based operating system implementations. In other embodiments, the communication server 104 is, or includes custom or non-standard hardware, firmware, or software configurations.

In one or more implementations, the communication server 104 is a cloud-based server or computing instance. For example, the communication server 104 is a software instance operating on a cloud-hosted computing cluster, such as Amazon's AWS computing clusters. In this configuration, as depicted in FIG. 1, the communication server 104 and communication interface device 102 are connected to one another view a network, such as the internet. Likewise, remote computing device 110 and 108 are also network or internet connected devices such that the communication between these devices and the user devices 102 and the communication server 104 are through one or more networks. Furthermore, each of the communication server 104 and 108 are provided as part of a cloud computing platform.

In one or more alternative implementations some, or all, of the elements provided in FIG. 1 are connected via a local area network (LAN).

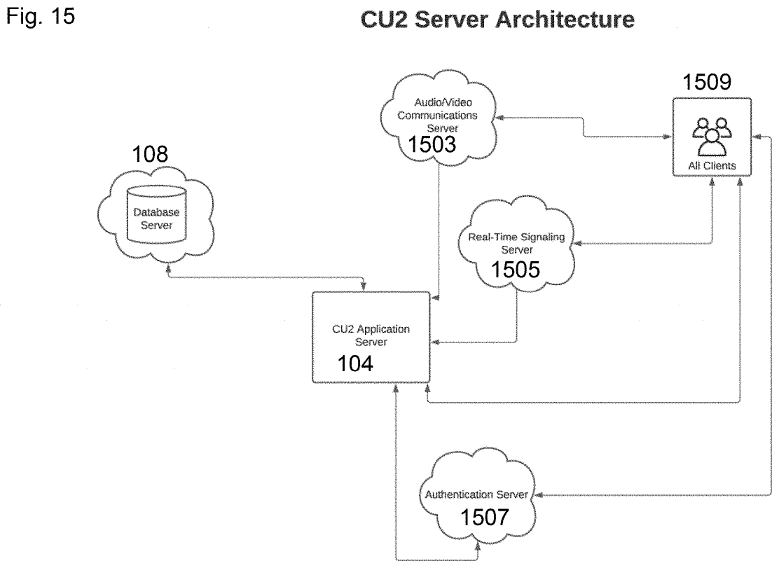

As shown in more detail in FIG. 15, the communication server 104 can be configured as a collection of interconnected modules that communicate with one another to carry out the particular features and tasks described herein. As shown, the communication server can include an application server 104, an audio/video communications server 1503, a real-time signaling server 1505, an authentication server 1507, and database server (such as but not limited to database 108). Each of these servers can be instantiated as one or more software processes or modules executing in a cloud computing environment, server cluster, computing array or other arrangement of computing elements configured to exchange data with the client systems 1509 (such as communication interface device 102, staff device 505 and the like).

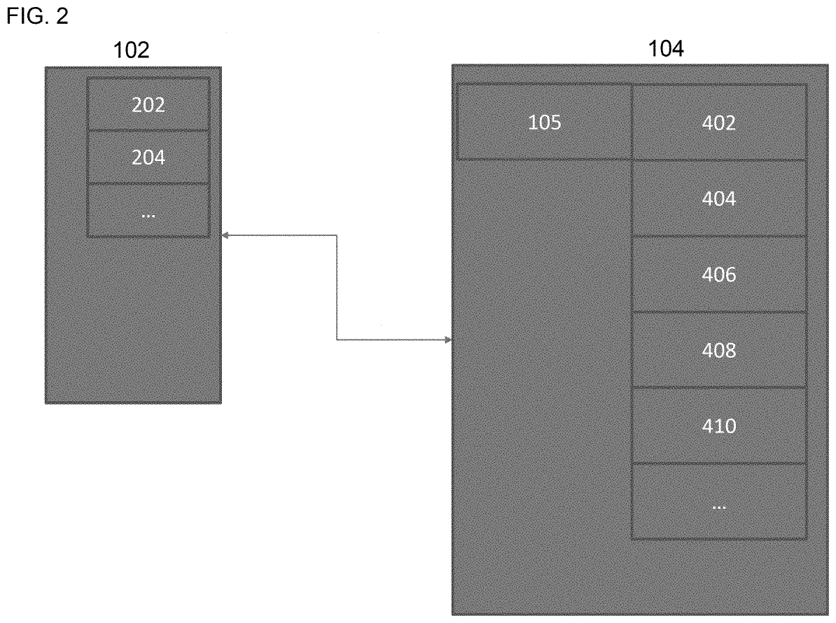

In one or more embodiments, the communication server 104 is directly or indirectly connected to one or more memory storage devices (memories) to form a microcontroller structure. The memory is a persistent or non-persistent storage device (such as memory 105) that is operative to store the operating system in addition to one or more of software modules, as shown in FIG. 2. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as through the use of removable media cards or modules. In one or more embodiments, the memory of the communication server 104 provides for the storage of application program and data files. One or more memories provide program code that the communication server 104 reads and executes upon receipt of a start, or initiation signal. The memories may also comprise secondary computer memory, such as magnetic or optical disk drives or flash memory. In one or more embodiments, the memory 105 of the communication server 104 provides for storage of application programs or modules and data files when needed.

As shown, memory 105 and 108 are examples of computer-readable tangible storage devices. A storage device is any piece of hardware that is capable of storing information, such as, data, program code in functional form, and/or other suitable information on a temporary basis and/or permanent basis. In one or more embodiments, memory 105 includes random access memory (RAM). RAM may be used to store data in accordance with the present invention. In general, memory can include any suitable volatile or non-volatile computer-readable storage device. Software and data are stored in 108 for access and/or execution by processors 104 via one or more memories of memory 105.

In a particular embodiment, 108 is a cloud-based storage device. For example, the 108 is a storage instance operating on a cloud-based storage system that includes a plurality of hard disk drives that are accessible remotely via a cloud interface. Alternatively, or in addition to a magnetic hard disk drive, 108 can include a solid-state hard drive, a semiconductor storage device, read-only memory (ROM), erasable programmable read-only memory (EPROM), flash memory, or any other computer-readable storage devices capable of storing program instructions or digital information.

The database 108 may be embodied as solid-state memory (e.g., ROM), hard disk drive systems, RAID, disk arrays, storage area networks (“SAN”), network attached storage (“NAS”) and/or any other suitable system for storing computer data. In addition, the database 108 may comprise caches, including database caches and/or web caches. Programmatically, the database 108 may comprise flat-file data store, a relational database, an object-oriented database, a hybrid relational-object database, a key-value data store such as HADOOP or MONGODB, in addition to other systems for the structure and retrieval of data that are well known to those of skill in the art.

The media used by 108 may also be removable. For example, a removable hard drive may be used for 108. Other examples include optical and magnetic disks, thumb drives, and smart cards that are inserted into a drive for transfer onto another computer-readable storage medium that is also part of 108.

In one or more implementations, the communication server 104 includes one or more communications or network interface units. These units provide for the ability to transfer data obtained from the communication interface device 102 to one or more remote devices 110. In one or more implementations, the communications unit may provide appropriate interfaces to the Internet or other suitable data communications network to connect to one or more servers, resources, API hosts, or computers. In these examples, communications unit may include one or more network interface cards allowing for Bluetooth, ZigBee, serial, ethernet, or other wired or wireless communication protocols. In one or more implementations, the communication unit allows for data processed by the communication server 104 to exchange data in real-time or near real-time with a user interface device 106 or databases 108.

In an alternative implementation, the data can be exchanged with the communication interface device 102 and the associated communication server 104 using a remote computing device 110. Here the remote computing device 110 is a remote computer that can receive, and display data sent by the communication server 104. For example, data processed by the communication server 104 is transmitted to the remote computing device 110 and displayed on a display device that is associated with the remote computing device 110. By way of non-limiting implementation, the remote computing device 110 is a portable computer (such as a mobile telephone, portable computer and other devices) that is configured to receive data from the processor and display that data on a screen incorporated into such a remote computing device 110. For example, a staff user 505 is able to communicate with the user 503 via their connection to the communication server 104.

Those possessing an ordinary level of skill in the requisite art will appreciate that additional features, such as power supplies, power sources, power management circuitry, control interfaces, relays, interfaces, and/or other elements used to supply power and interconnect electronic components and control activations are appreciated and understood to be incorporated.

In one or more particular implementations, the communication server 104, as well as the audio/video communication server 1503, real-time signaling server 1505 and authentication server 1507, are configured to provide intelligent communication routing. While the forgoing examples provide a server mediated system, it will be appreciated that the communication sessions (referred to herein as “calls”) can either be processed through a server (such as Audio/Video Communications Server 1503) or be performed P2P (Peer-to-Peer) using suitably configured communication interface devices and the availability of network connections. Such functionality (either server based or P2P) is based upon the functionality desired (i.e., recording) and cost-effectiveness.

As provided in more detail herein, a feature-rich and lowest-cost solution is provided that overcomes significant defects and drawbacks present when existing communication systems are used in circumstances where the users have adaptability challenges and special user needs. For example, the foregoing description provides for additional features that are associated with pre-determined actions, such as different call buttons causing different functionality. For example, when a “medical” button activated, the server is configured to record such calls. Likewise, a “record” option is provided during the communication sessions so as to ensure compliance with medical privacy and patient advocacy. Such communication sessions can extend to alternative meeting types beyond simple two-way communications. For example, the described systems are also available to permit recordation of scheduled meeting (i.e., plan review meetings are recorded). Additionally, the server and communication infrastructure provided can integrate with smart home devices or provide custom, autonomous or machine learning based detection of certain audio/video events.

Furthermore, in one or more implementations, the system described includes a dynamic UI that can be configured based upon a user's needs. For example, traditional controls such as a call button are, in one or more implementations PIN protected to prevent nuisance calls. Likewise, requests for a call can be routed through the authentication server 1507 so as to require authentication prior to initiation of a call.

For example, a client user device (such has the communication interface device 102) is configured with a communication software application that maintains a real-time communication link to the communication server 104. The communication software application is configured to not display user interface elements that would permit the user of the client user device to initiate a communication session. Upon initiation of a communication request by a staff user device 105, the client user device is configured to automatically accept the request and begin the communication session. In another configuration, the user interface of the client device is configured to request a pin or password prior to initiating a communication request. Here, the user's communication request is routed to a an authentication server 1507. In one or more implementations, the authentication server 1507 is configured to evaluate a one-time or single use PIN that allows the user to initiate the communication session. In another configuration, the authentication server 1507 includes a user device call list of approved communication requests that can be made without a password or pin. Call requests made to individuals not on the list would then require a password that is evaluated by the authentication server 1507. Where the password is accepted, the authentication server 1507 routes the initiation request to the communication server for transmittal to the intended recipient.

In one or more further implementations, the user interface of the communication interface device is configured so that the user is prevented from accidentally terminating the session. Icons or graphics used on such buttons could be similarly chosen/configured based upon the individual using the system.

In a further implementation, the communication server 104 and/or the communication interface device 102, are configured to record the details of call sessions and store those details in the database 108. For example, the communication server 104 is configured to store the details of a given call session, such as when the call occurred and who participated (for how long). Such information can be viewed on screen, exported, or electronically transferred to other systems (e.g., a doctor's Billing system). At the same time, real-time call notifications can be generated. For example, should a call be made for medical assistance, a support staff member could be instantly notified.

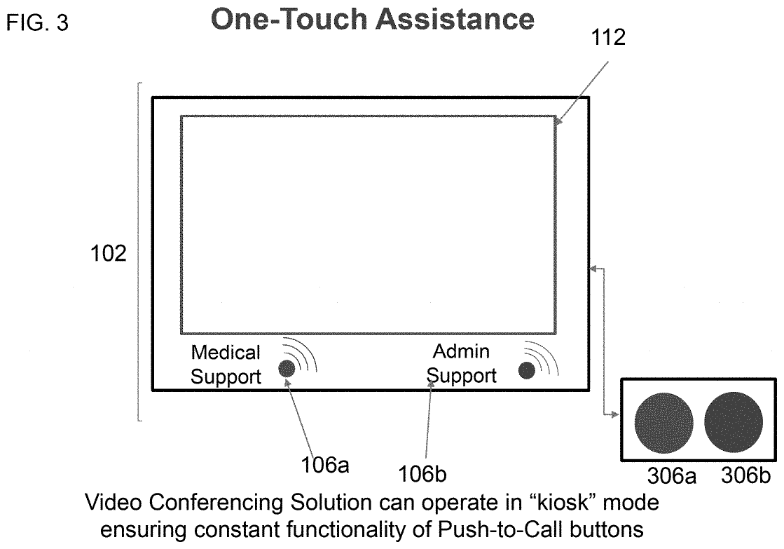

As noted, in existing communication devices, the communication software can be closed or turned off such that a user will not receive communications intended for the user. Likewise, the user if desiring to initiate a communication, will need to access the specific communication application and engage in a startup or initiation process. Turning now to FIG. 3, the communication interface device 102, is configured to allow for easy deployment of communication or conferencing services to users of differing skill level, ability, and mobility. As described, the communication interface device 102 is configured with multiple input devices that allow for use of the communication interface device 102 by persons with adaptability needs. For example, in one, the input devices are software-based buttons (106a, 106b) provided on a touch screen or other input device. In another implementation, the communication interface device 102 includes one or more hardware-based input devices. For example, the hardware input devices (such as buttons, switches or toggles) 306a, 306b, can be connected to the communication interface device 102 to allow for a user to interact with physical input devices. In one or more configurations, the hardware input devices 306a, 306b are configured to transmit user input directly to the communication interface device 102. In alternative configurations, the hardware input devices 306a, 306b are configured to transmit user inputs, via wired or wireless communication linkages, to a server, such as server 104, which in turn provides the relevant signal to the software operating on the communication interface device 102.

In one or more implementations, the communication interface device 102 is configured to receive incoming communication requests. In one arrangement, the communication interface device 102 is always active (such that the one or more output devices 112 is on and displaying information) and ready to receive communications. In another arrangement, the communication interface device 102 is always active (such that the one or more input devices (e.g., camera or microphone) and ready to transmit information. In one or more further arrangements, the communication interface device 102 is configured to be active at certain times. For instance, the communication interface device is active between operating or visiting hours of a medical, or care facility. Alternatively, communication interface device 102 is configurable into a power-save or standby mode. However, this stand-by mode still allows for the receipt of incoming communication requests. Likewise, in stand-by mode the communication interface device 102 is configured to initiate communication requests when a user interacts with one of the input devices 106a or 106b. For example, where the communication interface device 102 is in stand-by mode, the software-based input devices (106a) are not displayed on the one or more output devices 112. However, interaction with the input devices 106b will still be received and processed by the communication interface device 102. Likewise, an incoming communication request will cause the one or more output devices 112 to turn on and display the relevant communication session information.

As shown in FIGS. 1, 3,5-6 and 12, the communication interface device 102 includes one or more input devices 106a or 106b that allow the user 503 to initiate a communication session with a remote user 505. For instance, a user interface 502 displayed on the one or more output devices 112 allows a user to select the particular individual they wish to communicate with. For instance, the user interface 502 provides a list of individuals or a remote user 505 that can be contacted to begin a communication session. In one or more particular implementations, a processor of the communication interface device 102 is configured by one or more software modules to access a data storage location and obtain contact information for one or more individuals. For example, the data storage location is configured as a local or remote database that includes one or more entries, where each entry incudes a reference to a user (such as name of alias) and communication linkage initiation function. Here, each entry in the database associated with a name includes one or more instructions or function. For instance, a unique identifier, such as but not limited to, a mobile or landline telephone number, chat handle, email address, URL identifier or other reference that is parsable by the communication server and causes the communication interface device 102 to initiate a communication session with the intended recipient.

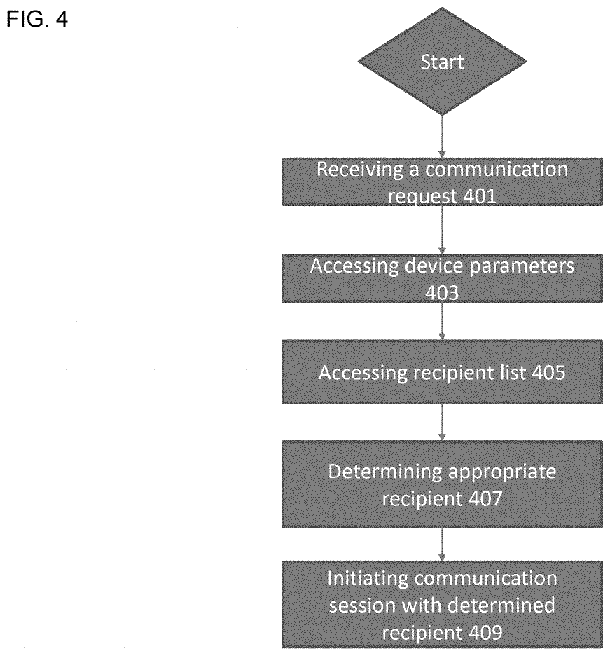

For example, one or more input modules 202 configure a processor of the communication device 102 to receive an input from the input device 106a or 106b and initiate a communication session with a pre-determined recipient or remote user 505, as shown in step 401 of FIG. 4. In one or more implementations, the input module 202 also configures a processor of the communication interface device 102 to accesses data from the communication interface device 102, such as the location of the device (according to a preset field or dynamically obtained using GPS or other positioning systems), date, and time, as shown in step 403.

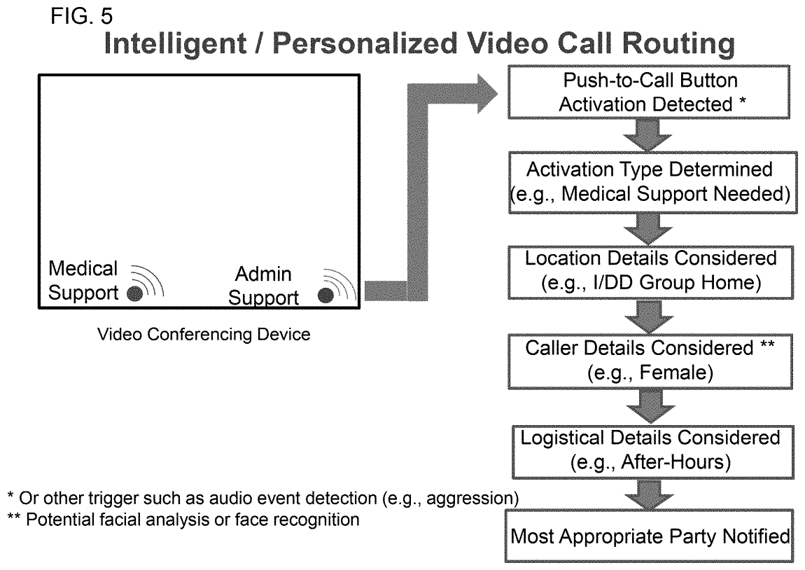

As shown in FIGS. 4-5, interacting with one input device (such as via the input devices 106a or 106b) causes the communication interface device 102 to send a request to the communication server 104 for medical support. Here, the communication server 104 is configured to receive the medical support request and initiate a communication link with an available medical support user. In one or more particular implementations, communication server 104 is configured by one or more software modules to access to a lookup table of medical support users that are qualified to receive a communication from a particular class of user. In a further arrangement, the communication server 104 is configured, by one or more software modules, to determine the time of day the communication is sent and identify a particular medical support user that is scheduled to be available at the time the communication is sent. For example, as shown in step 405, the communication server 104 is configured by a routing module 402 that routes the communication based on the time of day, the location of the communication interface device 102 and the input received. In the foregoing example, where the input received is in response to the user interacting with the “medical support” input, the communication request is routed by the communication server 104 to the appropriate recipient. For example, the appropriate recipient is at a medical care facility, home care facility or other location. By way of non-limiting example, based on the location and time of day, the communication server 104 is configured by one or more software modules to access a duty log or roster of care providers to determine the proper recipient of the communication, as in step 407. Furthermore, in one or more implementations, the communication server 104 is configured to identify available recipients, such as by polling the activation state of one or more remote communication devices and routing the communication to an available care provider as shown in step 409.

Returning to FIG. 2, in one or more further implementations, the user can interact with an administrative support interface. Interacting with such an interface causes one or more processors, configured by a routing software module, to route a call, using the input module 202 and the routing module 402 to an administrative support provider. For example, where an administer oversees a collection of different locations, the input module 202 combines location data with the request. The routing module 402 causes the processor to identify the proper administrative support provider based on one or more references tables, linked lists, databases or other data arrangements and routes the communication accordingly.

As noted, additional interfaces can be provided beyond physical interfaces. For example, a user may initiate the pre-determined call process outlined in steps 302 and 304 by voice command, gesture interface or motion recognition. In the implementation where the communication interface uses motion interface, one or more cameras are configured by a motion capture module 204 to capture motion taking place before the communication interface device 102. Such motions could be a hand wave, sign language, movement pattern or other repeated motion by a person that is correlated with a desired communication session. For instance, a particular movement pattern is identified and correlated based on data stored in the communication server 104 (or database 108). In one particular implementation, a neural network or other machine learning based system is trained on a collection of user images that have been correlated with specific gestures. Once trained, such a machine learning system is utilized to evaluate the gestures of a user to generate an associated command. Regardless of the image or pattern analysis system used, upon matching a detected movement pattern with a specific data file, the communication server 104 is configured by the motion capture module to establish a communication session between the users.

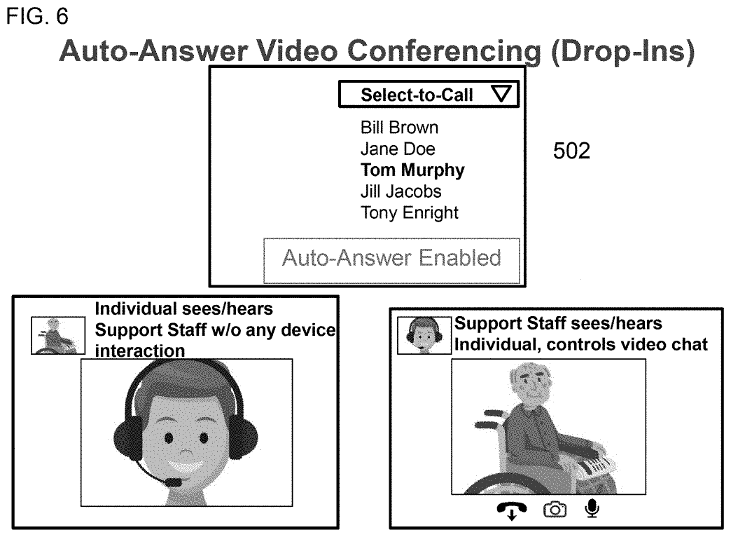

In one or more further implementations, as shown in FIG. 6, the communication server 104 is configured to cause the communication interface device 102 to activate so as to establish the communication session. As shown in FIG. 6, the remote user has access to a user interface 502 that provides a number of potential recipients. In certain circumstances, a user is unable to answer an incoming communication request. For example, a user may have limited mobility, access or cogitative ability to establish the communication session requested by an outside party. As such, when a remote user 505 seeks to access a communication interface device 102 to initiate a communication session, the communication server 104 will initially send an access request flag to the communication interface device 102. Such a flag might cause the communication interface device 102 to present an alert that a session is requested. Where the user is unable to acknowledge the session flag, the communication server 104 is configured to send session initiation flag to the communication interface device 102 that will automatically initiate the communication session. By way of non-limiting example, the communication interface device is configured to automatically initiate a communication session after a pre-determined period. For instance, if 20 seconds have elapsed from the initiation of the communication secession without acknowledgement by the user of the communication interface device 102, the communication interface device 102 will automatically accept the communication request and begin the communication session.

In instances where privacy concerns are paramount, or the potential for nuisance activations exist, the communication server 104 first requests a password or code from the user initiating the session. In one implementation, the password is stored in a database file in the database 108. However, in an alternative configuration, the password is stored on the communication interface device 102 and only if the password is accepted by the communication interface device 102, does the communication session initiate.

For example, and building on the previous implementation, where the user has not acknowledged the communication request after 20 seconds, the communication server requests a password from the initiator of the communication request. Upon receipt of a valid password associated with the communication device requested, the communication session will initiate.

In one or more further implementations, the authentication process is managed by the authentication server 1507. In one or more implementations, the authentication server 1507 is independent of the communication (or application) server 104.

In other implementations, the communication server 104 grants access or initiates an incoming communication based on prior authentication and/or user access levels. For instance, where the call initiator is a super-user, the communication interface device 102 accepts and initiates the communication session. Here, the recipient communication interface devices 102 has been configured to accept communications from super users. In alternative arrangements, legacy username and password combinations are whitelisted by the communication interface device 102 such that upon receipt, the communication session is initiated. Likewise, other authentication approaches, such as Single Sign On can be used to authenticate the remote user seeking to initiate the communication session.

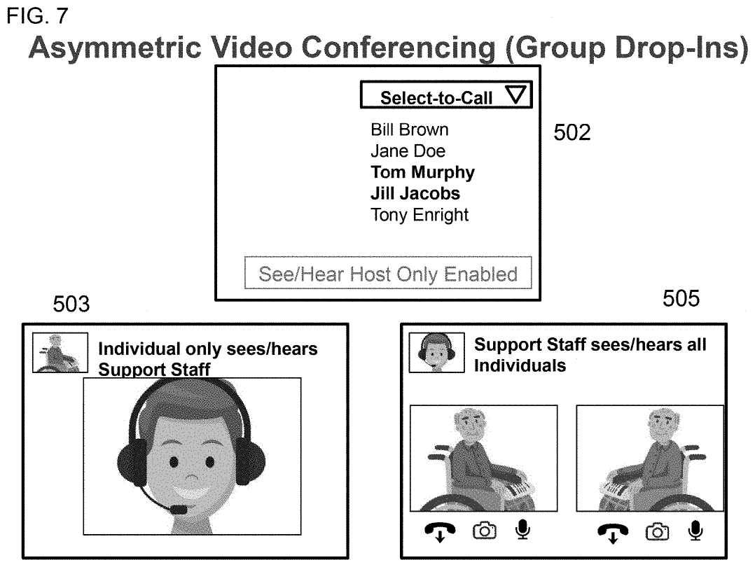

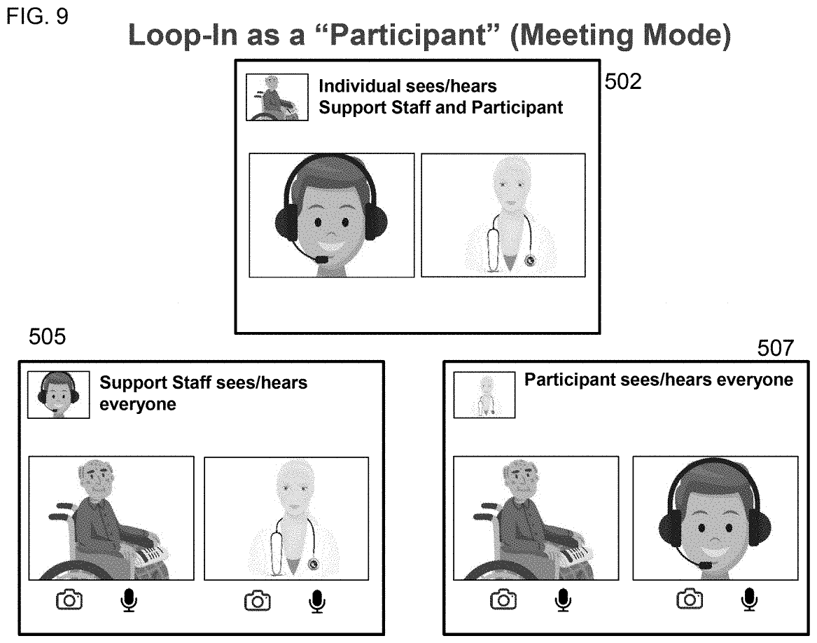

In one or more further implementations, the communication session can be controlled by the remote user 505 to allow for additional participants. For example, as shown in FIGS. 7-10, where the remote user 505 in the communication session is a medical care professional, the medical care professional can add additional participants to the call without authorization from the user 503. A session expansion module 404 configures the communication server 104 to add additional participants to a communication session based on one or more user inputs received from either the communication interface device 102 user or the remote user 505.

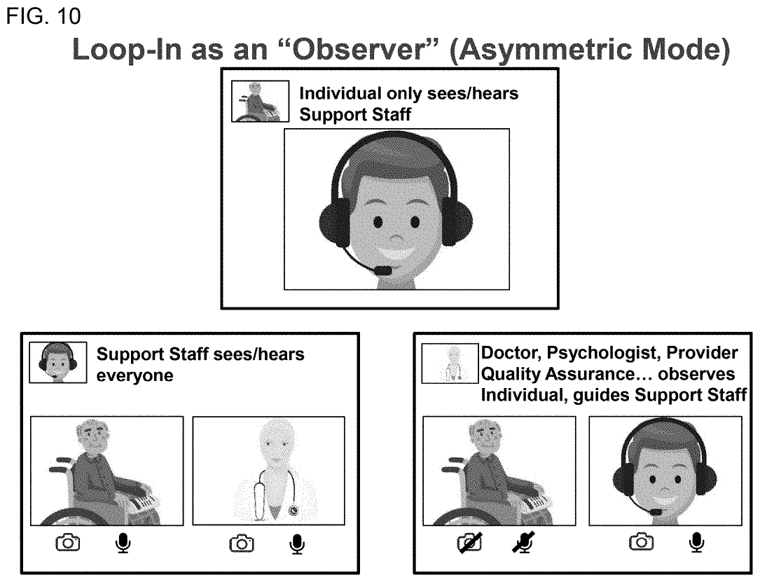

In one or more implementations, as shown in FIG. 10, the remote controller (such as remote user 505) of the session is able to add additional participants that are not seen or heard by the user system. For example, the remote user 505 is able to select from the communication session user interface 502, additional users. However, these additional users can be added in a “spectating” or “passive” manner so as to not be present on the user 503's display. In this manner assessments or sensitive subject matter can be discussed with additional monitors present, but not participating, in the communication session.

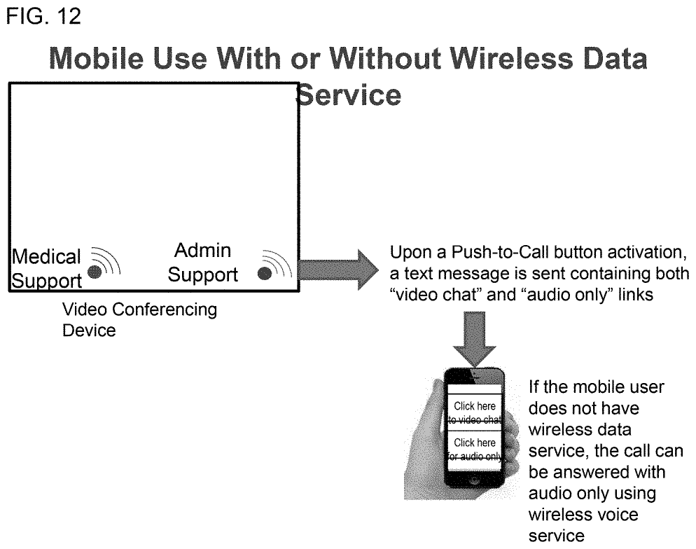

In one particular implementation, data packages, objects or files can be sent to a new user to allow them to access the communication session using an available device. For instance, as shown in FIG. 12, the communication server 104 is configured though a session link module 406 to generate a text message link to a new participant of the session. The text message link, upon interaction on a communication device (such as but not limited to a smartphone, tablet or portable computer) causes the communication device to access the session in progress. By way of non-limiting implementation, such a link included in the text message causes a web browser window to open that is configured to receive the session in progress and as mediated or hosted by the communication server 104.

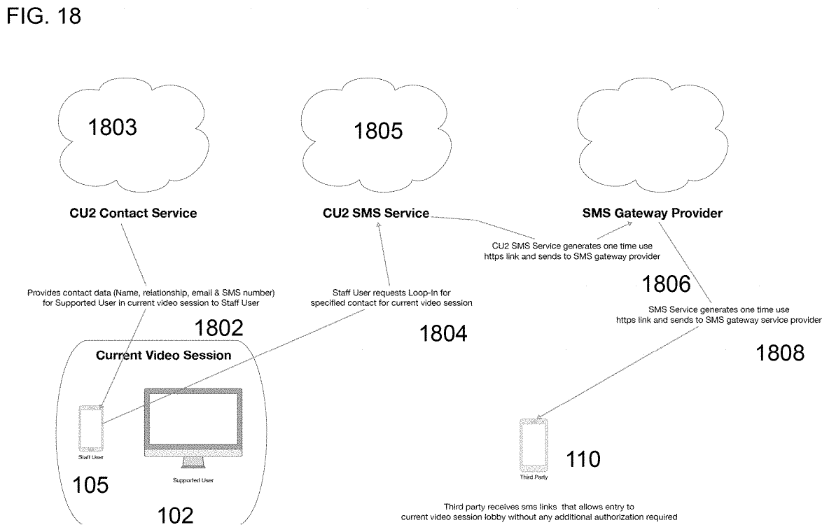

By way of further example, the communication server 104 is configured to generate and send a text message or SMS link to a third-party user. For example, where the communication session is initiated by a staff user, the staff user can select an individual for inclusion in the communication session. As shown in FIG. 18, the staff user can select a pre-determined user, or provide the communication server 104 with the communication details of a desired contact. For example, a contact service module 1803 configures the processor of the communication server 104 to receive communication details of an intended new participant, as shown in step 1802. Once the staff user has the relevant contact information, a contact request is sent to the SMS server as in step 1804. The contact request can include information requesting the type of communication session request (such as “loop-in” or “private”). In one or more particular implementations, a SMS module 1805 configures the processor of the communication server 104 to generate a one-time use link that provides access to the current session, as shown in step 1806. Such a link will provide the third-party access to the type of communication session requested by the staff user. As shown in step 1808, a SMS gateway provide receives the link, or other data generated by the SMS service module 1805 and in turn sends a SMS text message containing the link to the identified recipient (user 110).

In yet a further implementation as shown in FIG. 12, the user 503 initiates a communication session with a remote user. In one or more circumstances, the remote user is not in a location where the remote computing device 110 has an active data connection. For example, in one or more implementations, the remote user can only receive cellular text messages on the remote computing device 110. In one arrangement, the communication server 104 attempts to determine if the remote computing device 110 has a data connection. For example, a URL or other resource link is provided to the remote user. Accessing this link will cause data connected or enabled device to initiate a data communication session with the communication server 104. In one or more further arrangements, the URL causes the remote device to transmit system settings, configurations, and network status to the communication server 104. Here, the processor is configured by the remote session module 406 to evaluate the remote device configuration and determine, based on the configuration data, if a data communication is possible or authorized.

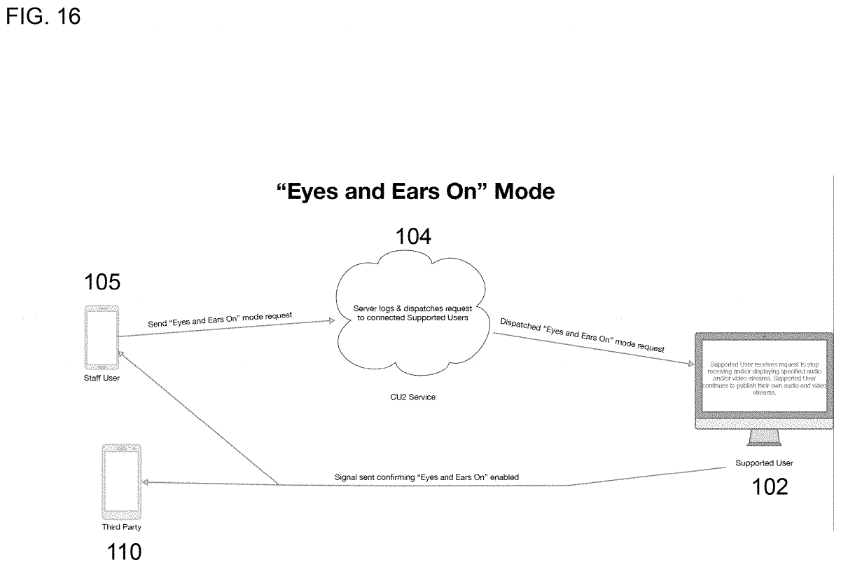

By way of further explanation and example, in the video solutions of the present art, a participant on a group call can be prevented from being heard and/or seen (by muting their microphone or disabling their camera). In the approaches described herein, what/who a participant hears and/or sees can be controlled. One or more commands, flags or signals are sent by the communication server 104 to the user interface device 102. For example, where the user interface device 102 is located in a group home facility, (e.g., a Residential Display), the communication server 104 can instruct the communication interface device 102 to selectively receive and/or display the audio/video streams of other participants, such as remote users 110. For example, during “Eyes & Ears On” supervision, as shown in FIG. 16, the local communication interface device 102 no longer displays audio and/or video streams of other participants yet continues to send their own audio and video streams.

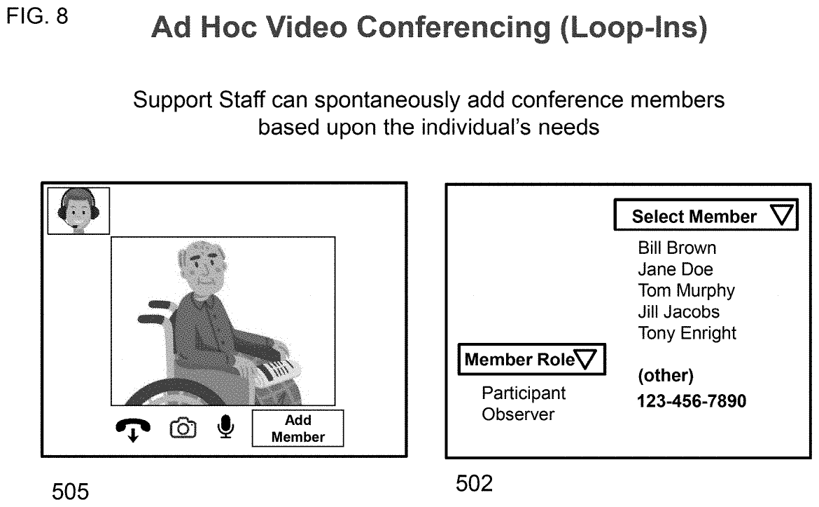

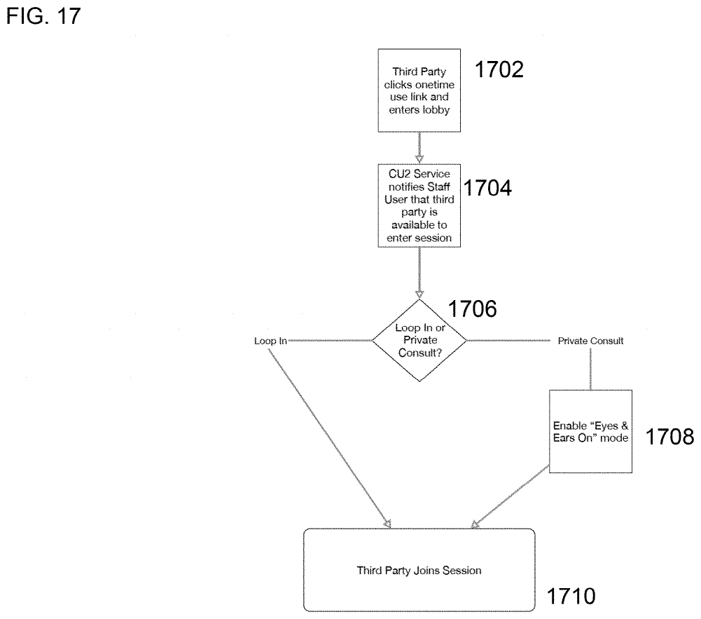

Likewise, in the “Loop-In” configuration (as shown in FIGS. 8-10, and 17) a third party, the residence is instructed to spontaneously display those video and audio streams. For example, as shown in FIG. 17, a link is provided to a third-party user as in step 1702. Here, the communication server 104 is configured to generate a link to an active communication session and send the link to the intended recipient. Upon accessing the link, the communication server 104 provides a notification to the session controller (staff user) that the third-party is available. The staff user is provided with one or more pre-determined option for admitting the third-party user. For example, based on the communication session, the staff user is able to determine whether to loop-in the third party or have the third party consult on the communication session, as shown in step 1706. Where the staff user selects private consultation, the communication server is configured to implement the “eyes and ears mode” as shown in step 1708. Here, the third party is able to see and hear the communication session but is unable to interact with the communication session as shown in step 1710. Where the staff user selects private consult the third party is permitted to participate in the communication session.

It will be appreciated that in addition to two-way audio/video, other content (such as videos and reminders) can be displayed interaction-free using such control signals. This “signaling” is separate from that used for (managing) two-way video and thus be agnostic, could be used with different video protocols. Accordingly, such signaling could occur through either in-band or out-of-band interfaces. In one or more implementations, such signaling is handled by the real-time signaling server 1505. Many of today's existing protocols including Messaging channels (such as those used in “chat” rooms) could be used for such signaling. In this configuration, the communication server is able to receive messages or signal from one or more third-party communication applications and integrate the communication signals into the communication session in progress.

Where the communication server 104 cannot determine that the remote computing device 110 has a data connection, or a data connection is not available or authorized, the communication server 104 generates a text message for transmission to the remote computing device 110 over a cellular communication channel. Here, the text message will include a telephone number that the remote computing device 110 can use to connect to a conference bridge established by the communication server 104 between communication interface device 102 and the remote computing device 110. For example, the communication server 104 is configured to provide a telephone number to a SIP interface that coverts the audio component of the communication session from user interface device 102 to telephone service which the remote computing device 110 is able to receive and access.

In yet a further implementation, where the communication interface device 102 is inoperative, lacks access to a network connection, the communication server 104 is configured to poll devices that are within a pre-determined geographic range of the communication interface device 102. For example, the communication interface device 102 is located within a care facility. In the event of a network outage or power outage the communication server 104 identifies one or more communication devices that are co-located with the communication interface device 102. For example, the communication server 104 is configured by one or more co-location modules 408 that poll available communication devices within the same geographic area as the inactive communication interface device 102. Here, the connected communication interface devices are configured to periodically transmit IP address, GPS coordinates or other location information to the communication server on a regular basis. In a further implementation, where the communication interface devices 102 are associated with one another based on a given location (such as a group home), such devices are grouped together as co-located in one or more databases or data storage devices. Using this information, the co-location module 408 configures one or more processors of the communication server 104 to automatically group co-located devices.

Once a device has been located, the communication session can then be routed to one of the co-located devices. By way of non-limiting example, in the event of a power outage or natural disaster the network connection of a given communication interface device 102 may be lost. However, cellular networks may still be operational, and a co-located communication interface device is able to communicate with the communication server 402 using a cellular network connection. In this arrangement, a medical professional or family member is able to request a communication session and have that communication session routed to the communication device that is located within the pre-determined proximity of the non-operative communication interface device 102. For instance, the communication server 104 is configured to receive a communication request for a communication interface device 102 that is not connected to the communication network. The communication server 104 is configured to identify a co-located communication interface device 102 and route the communication request to the identified co-located communication interface device. In this configuration, the communication request will include one or more flags, alerts, or notifications that the incoming request is intended for a specific recipient associated with an unavailable communication interface device 102.

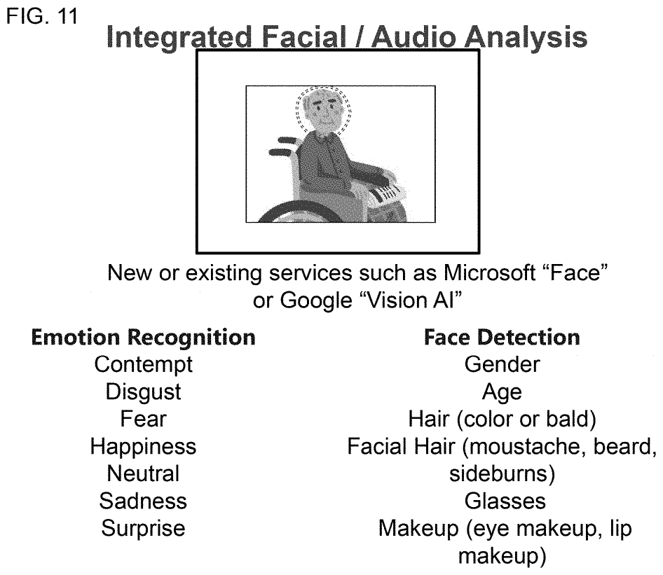

In a further implementation, as shown in FIG. 11, the communication server 104 is configured with additional modules that allow for analysis of the communication session participates to derive assessments about the participants health, wellness, or wellbeing. By way of non-limiting implementation, the communication interface device 102 and communication server 104 can be configured to access and evaluate unfettered verbal and nonverbal information. Such data can be collected using the one or more one or more devices, such as a still camera or an audio/video camera (1401). Where a user, such as a patient is in a relatively consistent user position, the communication interface device 102 and communication server 104 are configured to record such data and provide it to one or more machine learning (ML) and/or artificial intelligence (AI) modules. Here, such a video conferencing solution, incorporating enhanced capabilities such as audio/video content analysis and a rules engine, enables profound benefits to the care population by providing real-time remote assessments of a user.

By way of further example, the communication interface device 102 and communication server 104 can work in conjunction with one another to facilitate mental-health diagnosis and treatment. For example, either the communication interface device 102 or communication server 104 is configured with an analytic module 410 (as shown in FIG. 2) that allows for assessments of a session participant using one or more facial expression analysis submodules to identify facial expressions and/or voice analysis modules to identify patterns related to a specific condition. For example, the analytic module 410 configures the communication interface device 102 or the communication server 104 to evaluate a session participant to determine the depression level of the session participant. While the present description provides that the analytic module 410 is a module incorporated into the modules residing in the communication server 104, in alternative configurations, the analytic module 410 or other modules can be remotely accessible by the communication server 104.

In yet a further implementation, the analytic module 410 configures the communication interface device 102 or communication server 104 to aid in the diagnosis of various health conditions by visually detecting changes in color of skin, facial blood flow, or head movement, heart rate, breathing rate and blood pressure. Prior measurements of a particular session participant can be stored in the 108 for reference by the analytic module 410. For example, where a session participant has a regularly scheduled communication session with a care provider, various biometric measurements of the session participant are captured using video and audio input devices. Upon a subsequent session, the analytic module 410 is configured to compare current biometric measurements of the session participant with the prior measurements. By way of particular example. The analytic module 410 configures the processor of communication interface device 102 or communication server 104 to evaluate or provide estimates of a session participants' wellbeing based on audio input data. For example, the analytic module 410 allows for the determination of the presence of a respiratory disease such as pneumonia, asthma, bronchiolitis, croup, and lower respiratory tract infections in a session participant using audio-based software technologies. For instance, an audio input that captures a cough emanated by a session participant is provided to one or more machine learning algorithms or models that have been trained on a sample training data set of coughs. Such a training set allows a model to be generated that accepts new audio data as an input and generates probabilities that the audio data is indicative of one or more particular ailments.

In yet a further implementation, the machine learning models utilized by the analytic module 410 configure either the communication interface device 102 or communication server 104 to evaluate the general appearance of a session user to determine their overall wellbeing state. For example, the video and audio input data can be compared to prior historical image data for the participant to determine if the participant has maintained a grooming regimen. For example, by isolating head hair length or facial hair growth, the analytic module 410 is configured to evaluate whether the session participant has maintained a grooming procedure. While failure to groom may not be indicative of emotional or social wellbeing, such data can be used to evaluate the session participant by a qualified health care provider. Furthermore, in the event that multiple individuals are to be evaluated by a health care provider, such data can be used to rank or prioritize those persons in more need of support or assistance.

Overall, the communication interface device 102 and communication server 104 can be configured to evaluate the schedule periodic sessions with a care provider. As such, the analytic module 410 is configured to alert one or more care providers or other individuals when such an individual misses a scheduled appointment. In addition, the communication interface device 102 and or communication server 104 are configured to display audio/visual content such as reminders to perform Activities of Daily Living (ADLs) or Instrumental Activities of Daily living (IADLS) such as taking medicine. In the event that such activities are missed, the communication interface device 102 or communication server 104 is configured to generate alerts as reminders.

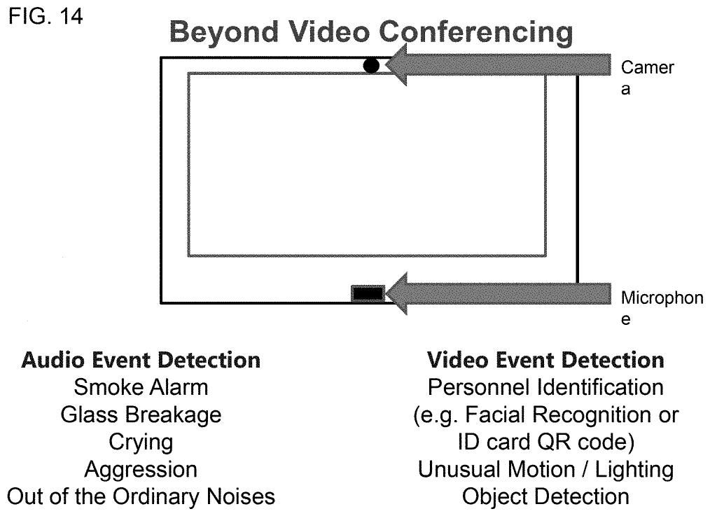

As shown in FIG. 14, in a further arrangement, the analytic module 410 is configured to detect adverse events transpiring in the immediate vicinity of the communication interface device 102. For example, in one or more implementations, the communication interface device 102 is configured to continuously monitor the audio data obtained from one or more one or more input devices 106. Such monitoring can be maintained even in the event that there is no ongoing session. For example, the communication interface device 102 is configured to identify elevated voices, such as yelling, screams and or other sounds related to physical abuse. Likewise, in one or more implementations, the analytic module 410 configures the communication server 104 to use natural language processing submodules to convert audio data into textual data and then obtain sentiment or tone analysis. Where such sentiment or tone analysis is indicative of disputes or violence, alerts can be generated and provided to one or more care providers. Likewise, the analytic module 410 is configured to identify distinct audio cues or alarms, such as identify glass breakage, smoke detectors and other potential safety notifications. Upon detecting such audio alerts, one or more notifications can be generated to alert the relevant individuals (either local or remote) of such conditions.

As noted, video conferencing systems are frequently desired to be installed in common areas, like a group home's living room, where they can benefit multiple individuals. While a single stationary system, in a central location, is often the most convenient and least expensive, its application is limited. Most significantly, these placing such systems in a common area mean that such systems cannot be used for telehealth where privacy is required due to HIPAA regulations. Alternatively, a stationary device is less useful when detailed images of a particular ailment or individual need to be taken. As such, in one or more implementations, the session link module 406 allows for the session to be transferred from the communication interface device 102 to a mobile or remote computing device.

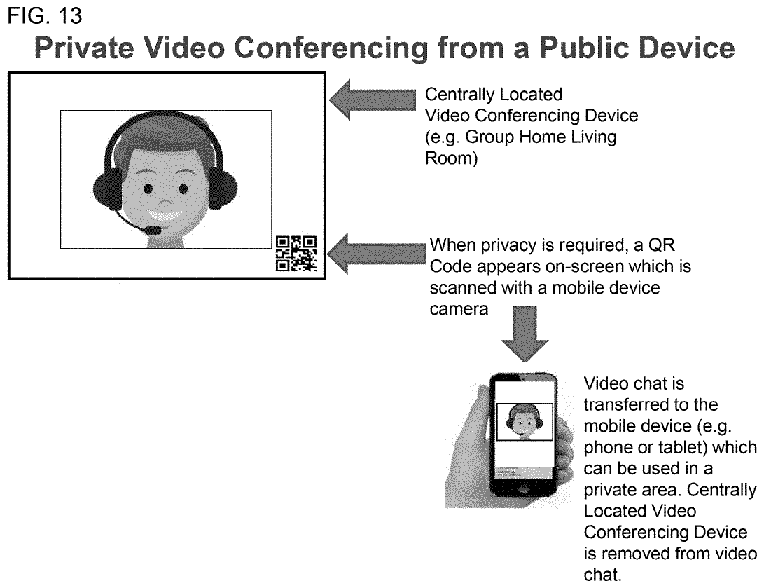

In one implementation, as shown in FIG. 13, the communication interface device 102 is configured to display a barcode, QR-code or other encrypted image on the one or more output devices 112. A remote device (such as a handheld, portable, or mobile computing device) can scan this code and cause the communication server 104 to permit the remote device to access the in-progress session. In one implementation, the existing session provided via communication interface device 102 is then terminated. However, in alternative configurations, the session provided in communication interface device 102 is maintained, and the session expansion module 404 configures the communication server 104 to add the remote device as a new participant in the communication session.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Publications and references to known registered marks representing various systems are cited throughout this application, the disclosures of which are incorporated herein by reference. Citation of any above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

While the invention has been particularly shown and described with reference to a preferred embodiment thereof, it will be understood by those skilled in the art that various changes in form and details may be made therein without departing from the spirit and scope of the invention. As such, the invention is not defined by the discussion that appears above, but rather is defined by the points that follow, the respective features recited in those points, and by equivalents of such features.

What is claimed is:

1. A communication system is provided comprising:
at least two user communication devices configured to send and receive at least audio-video data, and the at least two user communication devices are configured to broadcast their respective availability for a communication session; and
a communication server configured by one or more software modules to mediate a communication linkage between the at least two user communication devices, wherein the communication server is further configured to:
receive from a first user communication device of the at least two communication devices a request to initiate a communication session with a second of the at least two user communication devices;
transmit, to the second of the at least two user communication devices, the request to initiate a communication;
receive a communication session acknowledgement provided by the second user communication device;
establish a communication session between the first and second user communication devices where at least one of the first or second communication devices is designated as a client participant device and one of the first or second communication devices is designated as a managing participant, wherein during the duration of the communication session, a user interface of the client participation device is configured to not display a function to terminate the communication session.

2. The communication system of claim 1, wherein the designation of the client and managing participant is included in the request to initiate the communication session.

3. The communication system of claim 2 wherein:
where the request to initiate a communication session originates from the managing participant device, the request includes a dataset of communication functionality; and
the client participant device is configured to dynamically display on a user interface, the approved user functionality based on the dataset provided by the managing participant device.

4. The communication system of claim 2 wherein the communication server is configured to:
receive from either the client or managing participant device, a request to add a new participant to an existing communication session;
generate an interactive link providing access to the existing communication session;
transmit the generated interactive link to the new participant; and
upon receiving notification that the new participant has interacted with the interactive link, provide the new participant with access to the existing communication session.

5. The communication system of claim 4 wherein the request to add a new participant to an existing communication session includes a data value corresponding to one of a plurality of participation types.

6. The communication system of claim 5 wherein the plurality of participation types includes a passive participation mode and an active participation mode.

7. The communication system of claim 6 wherein selection of the passive participation mode causes the client participant device to transmit one or more audio or video streams to both the managing participant device and the new participant communication device and the new participant communication device to transmit one or more audio or video streams to the managing participant device.

8. The communication system of claim 7 wherein selection of the passive participation mode causes the user interface of the client participant device to display an indication that a passive participant is participating in the existing communication session.

9. The communication system of claim 7 wherein selection of the passive participation mode causes the user interface of the client participant device to not provide notification that a passive participant is participating in the existing communication session.

10. The communication system of claim 6 wherein selection of the active participation mode causes the second communication device to transmit one or more audio or video streams to both the managing participant and the new participant communication device and the new participant communication device to transmit one or more audio or video streams to both the client and managing participant devices.

11. The communication system of claim 4 wherein the communication server is configured to provide the access link to one of a message server, email server or SMS server.

12. The communication system of claim 2 wherein the second user communication device is configured to display the communication session request on a display device associated and a user interface element to accept the communication session request, where after a pre-determined time period had elapsed from the display of the communication session request and the user interface element has not been interacted with, the second user communication device is configured to accept the communication session request.

13. The communication system of claim 11 where the pre-determined time period is less than 30 seconds.

14. A communication system is provided comprising:
a user communication device that includes at least one user input device, whereupon interaction with the user input device causes a communication request to be generated, wherein the generated communication request includes at least a data value, and a request type value;
a communication server configured to receive the generated communication request and to parse the generated communication request to determine at least the request type and the data value and compare the request type and the data value to a lookup table of potential recipients of the communication request depending on the data value and request type, the communication server further configured to determine the availability of a recipient by obtaining the network status of a communication device associated with each potential recipient and identify an available recipient; the communication server further configured to initiate a communication session between the user communication device and the communication device associated with the selected available recipient.

15. The system of claim 14, wherein the data value is a time value.

16. The system of claim 15, wherein the communication server is configured to poll the availability of the recipient communication devices.

17. A communication system comprising:
one or more communication devices configured to communicate over a communications network and further configured to broadcast on the communications network, on a periodic schedule, a status notification;
a network monitoring appliance configured to:
access the communications network and receive the broadcast status notification,
generate an alert where a status notification from any of the one or more communication devices was not received according to the periodic schedule, and
transmit the alert using the communications network;
a recipient communication device configured to:
receive alerts transmitted by the network monitoring appliance, wherein the alert received include data values associated with the one or more communication devices that caused the generation of the alert.

18. The communication system of claim 17 wherein the status notification includes at least one geographic location indicator.

19. The communication system of claim 18, wherein the network monitoring appliance is further configured to:
identify at least one prior location of one or more communication devices that caused the generation of the alert based on the at least one geographic location indicator,
determine, from a received status notification, at least one of the one or more communication devices that is within a pre-determined geographic range of the one or more communication devices that caused the generation of the alert; and
route a communication request addressed to the one or more communication devices that caused the generation of the alert to the identified at least one of the one or more communication devices within the pre-determined geographic range.
